(19) United States
(12) Patent Application Publication
(10) Pub. No.: US 2021/0251412 A1
(43) Pub. Date: Aug. 19, 2021

(54) NEEDLES OF DECORATIVE ITEMS AND METHOD OF MAKING SAME

(71) Applicant: Belgravia Wood Limited, Hong Kong (HK)

(72) Inventor: Hylke Pas, Halle (NL)

(73) Assignee: Belgravia Wood Limited, Hong Kong (HK)

(21) Appl. No.: 17/248,999

(22) Filed: Feb. 17, 2021

Related U.S. Application Data
(60) Provisional application No. 62/977,954, filed on Feb. 18, 2020.

(51) Int. Cl. A47G 33/06; B44C 5/06

(52) U.S. Cl. CPC A47G 33/06; B44C 5/06

(57) ABSTRACT

A method of making needles of a decorative product includes following steps: embossing embossments along folding lines onto a sheet; and cutting the embossed sheet along cutting lines between folding lines to form needles.

### CROSS-REFERENCE TO RELATED APPLICATIONS

This application is based upon and claims priority to U.S. Provisional Application No. 62/977,954, filed Feb. 18, 2020, and entitled “NEEDLES OF ARTIFICIAL TREE AND METHOD OF MAKING SAME,” the entire content thereof is incorporated herein by reference.

### TECHNICAL FIELD

The present disclosure generally relates to artificial trees, wreaths and garlands, and more particularly, relates to the needles of artificial trees, wreaths and garlands, and methods of making the needles.

### BACKGROUND

In recent years, artificial trees become increasingly popular as decorations in homes and businesses because artificial trees can be re-used and are economical and environmentally friendly. Some artificial trees include needle-shaped foliage (hereinafter “needles” or “needle leaves”). The artificial Christmas tree is widely used in celebration of the Christmas holiday, and various types of artificial trees can be used during other occasions.

Retailers and consumers also increasingly desire more realistic looking trees, which resulted in manufacturers making molded needles. However, the molded needles are more expensive and heavier. Therefore, there is a need to make cost-effective and lightweight artificial trees with realistic needles.

### SUMMARY

In some embodiments, an exemplary method of making the needles, comprises one or more of following steps: embossing a plurality of embossments along a plurality of folding lines onto a sheet; and cutting the embossed sheet along cutting lines between folding lines to form a plurality of needles.

In some embodiments, a sheet for making needles includes a central area, and a plurality of needles. Each of the needles has a first end connected to the central area and a second end, and comprises an embossment along a folding line being parallel to a direction of the needle. The second ends of each of two adjacent needles are separated by a cutting line between the folding lines of the two adjacent needles.

In some embodiments, an artificial tree includes a plurality of branch parts. Each of the branch parts includes a midrib and a plurality of needles extending from the midrib. Each of the needles has a first end connected to the midrib and a second end, and comprises an embossment along a folding line being parallel to a direction of the needle.

### BRIEF DESCRIPTION OF THE DRAWINGS

Embodiments and various aspects of the present disclosure are illustrated in the following detailed description and the accompanying figures. Various features shown in the figures are not drawn to scale.

FIG. 1 illustrates a flowchart of an exemplary method of making needles for an artificial tree, consistent with some embodiments of the disclosure.

FIGS. 2A and 2B are elevation views of two exemplary patterns on sheets, respectively, consistent with some embodiments of the disclosure.

FIG. 3A is an elevation view of an exemplary sheet with folding lines, consistent with some embodiments of the disclosure.

FIG. 3B is a cross-sectional view of an exemplary embossed sheet compared with a flat sheet, consistent with some embodiments of the disclosure.

FIG. 3C illustrates an exemplary heated roller for the embossing process, consistent with some embodiments of the disclosure.

FIGS. 4A to 4D are exemplary elevation views of the sheet after the cutting, consistent with some embodiments of the disclosure.

FIG. 5A illustrates an exemplary sheet with needles having different lengths after the cutting, consistent with some embodiments of the disclosure.

FIG. 5B illustrates an exemplary sheet with needles having the same length after the cutting, consistent with some embodiments of the disclosure.

FIG. 6 illustrates an exemplary sheet that undergoes printing, embossing and cutting, consistent with some embodiments of the present disclosure.

FIG. 7A and FIG. 7B illustrate exemplary alternative patterns of the printed sheet, consistent with some embodiments of the present disclosure.

FIG. 8 illustrates an exemplary intermediate stage of assembling an artificial tree, consistent with some embodiments of the present disclosure.

FIG. 9 illustrates an assembled artificial tree, consistent with some embodiments of the present disclosure.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the disclosure. Instead, they are merely examples of apparatuses and methods consistent with aspects related to the disclosure as recited in the appended claims. Particular aspects of the present disclosure are described in greater detail below. The terms and definitions provided herein control, if in conflict with terms and/or definitions incorporated by reference.

Therefore, specific structural and functional details disclosed herein are not to be interpreted as limiting, but merely as a basis for the claims and as a representative basis for teaching one of skill in the art to variously employ the present disclosure in virtually any appropriately detailed structure. Further, the terms and phrases used herein are not intended to be limiting; but rather, to provide an understandable description of the disclosure. While the specification concludes with claims defining the features of the disclosure that are regarded as novel, it is believed that the disclosure will be better understood from a consideration of the following description in conjunction with the figures. It is to be understood that the terminology used herein is for the purpose of describing particular embodiments only and is not intended to be limiting.

The terms “a” or “an”, as used herein, are defined as one or more than one. The term “another” as used herein, is defined as at least a second or more. The term “provided” or “providing” is defined herein in its broadest sense, e.g., bringing/coming into physical existence, making available, and/or supplying to someone or something, in whole or in multiple parts at once or over a period of time. It should be noted that, the relational terms herein such as “first” and “second” are used only to differentiate an entity or operation from another entity or operation, and do not require or imply any actual relationship or sequence between these entities or operations. Moreover, the words “comprising,” “having,” “containing,” and “including,” and other similar forms are intended to be equivalent in meaning and be open ended in that an item or items following any one of these words is not meant to be an exhaustive listing of such item or items, or meant to be limited to only the listed item or items.

As used herein, unless specifically stated otherwise, the term “or” encompasses all possible combinations, except where infeasible. For example, if it is stated that an item may include A or B, then, unless specifically stated otherwise or infeasible, the item may include A, or B, or A and B. As a second example, if it is stated that an item may include A, B, or C, then, unless specifically stated otherwise or infeasible, the item may include A, or B, or C, or A and B, or A and C, or B and C, or A and B and C.

In some embodiments of the present disclosure, an artificial tree can include one or more branch parts. Each of the branch parts includes a midrib and needles extending from the midrib. Any one of the needles has a first end connecting to the midrib and a second end forming a tip part of the needle. The needles and the midrib can be made by a polyvinyl chloride (PVC) sheet or film. For example, the sheet may include polymeric material, such as polyethylene, polyethylene terephthalate, polypropylene, polyvinyl chloride, polyurethane, polypropylene glycol, polystyrene, or any combination thereof. In some embodiments, the needles can be made by a transparent or translucent sheet or film, such as a PVC translucent film.

In the process of making an artificial tree, a cutter can be used to cut the PVC sheet along equally spaced cutting lines. In some embodiments, the PVC sheet can be in green color for artificial Christmas trees, but the present disclosure is not limited thereto. In other embodiments, the PVC sheet can be made in different colors for Christmas and other occasions. In some embodiments, a different brown PVC sheet can be cut and wound around a wire branch to cover up the wire branch and provide a more lifelike appearance to the artificial tree. In some other embodiments, instead of the winding of a PVC sheet, brown paint can be used along the spine of a branch assembly.

Needles of an artificial tree can be made of polyethylene (PE), which can make an artificial tree more lifelike realistic. PE needles can be formed with molds that are designed to mimic real trees, e.g., fir tree. However, compared with PVC, PE is more expensive and heavier. Heavy weight is an issue because it adds to shipping costs, as well as the amount of energy used to transport the trees. In addition, heavier trees are less convenient for consumers to move or set up the trees.

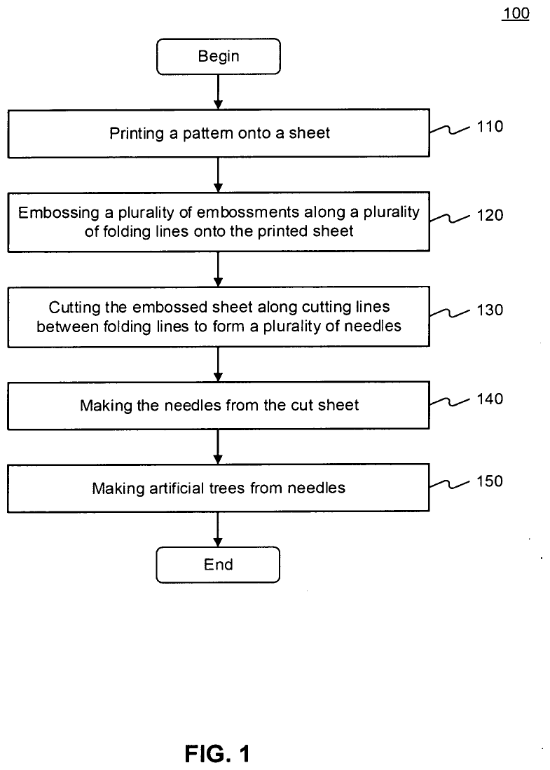

FIG. 1 illustrates a flowchart of an exemplary method 100 of making needles for an artificial tree, consistent with some embodiments of the disclosure. Steps delineated in FIG. 1 are merely in exemplary order of making artificial tree (e.g., Christmas tree), and may be carried out in different orders, with or without additional steps included therein. In addition, two or more blocks shown in this succession may be executed concurrently or with partial concurrence. Certain steps may also be omitted in FIG. 1 for the sake of brevity. In some embodiments, some or all steps shown in FIG. 1 can be combined into a single process.

At step 110, a pattern is printed onto a sheet. The term “sheet” is defined herein as a substantially flat planar item. In some embodiments, the sheet can be flexible, lightweight, printable or substantially continuous. The term “flexible” is defined herein as capable of bending easily without breaking.

In some embodiments, the sheet may include polymeric material. For example, the sheet may include a material of polyethylene, polyethylene terephthalate, polypropylene, polyvinyl chloride, polyurethane, polypropylene glycol, polystyrene, or any combination thereof. For example, the sheet can be made by polyvinyl chloride or polyethylene terephthalate. In some embodiments, the polyethylene terephthalate can be recycled material. In some embodiments, the sheet to be printed may be different colors depending on the base materials. In some embodiments, the sheet can be a transparent or translucent sheet or film, such as a PVC translucent film.

In some embodiments, the pattern appears as a raised image. In some embodiments, the pattern is flexographically printed onto the sheet. In some other embodiments, the pattern can be printed onto the sheet by using a laser printing machine, but the present disclosure is not limited thereto. The terms “flexographically printed”, “flexographic printing” and “flexography” are defined herein as a form of printing process which utilizes a flexible relief plate wrapped around a cylinder. In some embodiments, flexographic printing transfers ink to the plate by using a roller. In some embodiments, step 110 can be performed with a roller made of rubber. In some other embodiments, step 110 can be performed with a roller made of a material having the properties of rubber. According to some embodiments of the present disclosure, the pattern is then printed on the sheet by the plate.

In some embodiments, the flexographic printing is performed from origin on stem or midrib parts (e.g. the central area of the sheet) to tips of the needles (e.g., an edge of the sheet). In some embodiments, the sheet is printed on both surfaces of the sheet.

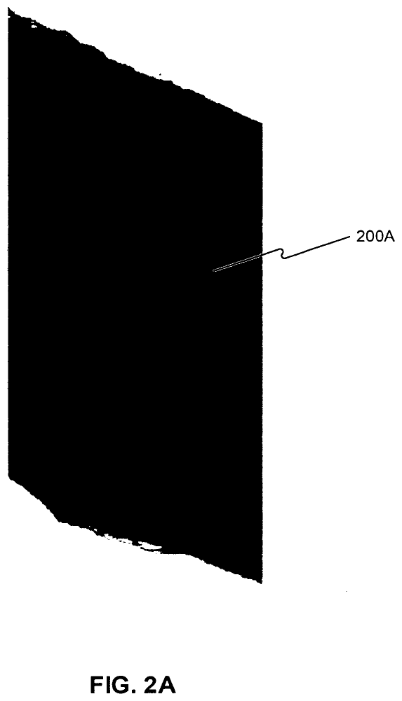

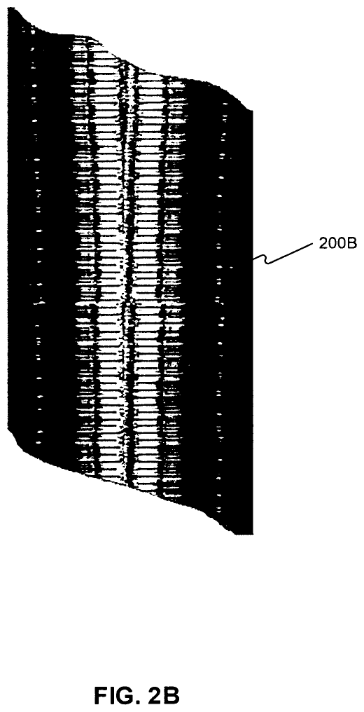

Reference are made to FIGS. 2A and 2B. FIGS. 2A and 2B are elevation views of two exemplary patterns on sheets 200A and 200B, respectively, consistent with some embodiments of the disclosure. As shown in FIG. 2A, in some embodiments, at step 110, a single color (e.g., green) pattern can be printed onto sheet 200A. As shown in FIG. 2B, in some embodiments, the pattern printed onto sheet 200B simulates and mimics a natural appearance of needles. Alternatively stated, the pattern can mimic the colors and appearances of needles as found in real trees, such as spruce, pine and fir trees. For example, as shown in FIG. 2B, the pattern may include two or more colors. In some embodiments, a first color, e.g., brown, can be printed at a central area of the sheet, and one or more second colors, e.g., different types of green colors, can be printed at edge areas of the sheet. In some embodiments, the green color of needles gradually fades from the edge to the stem to provide a gradient color effect. In some embodiments, the color of stem or needles can be mingled with white spots.

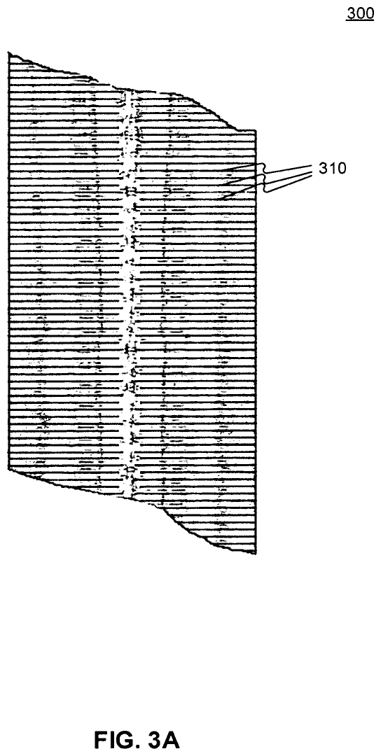

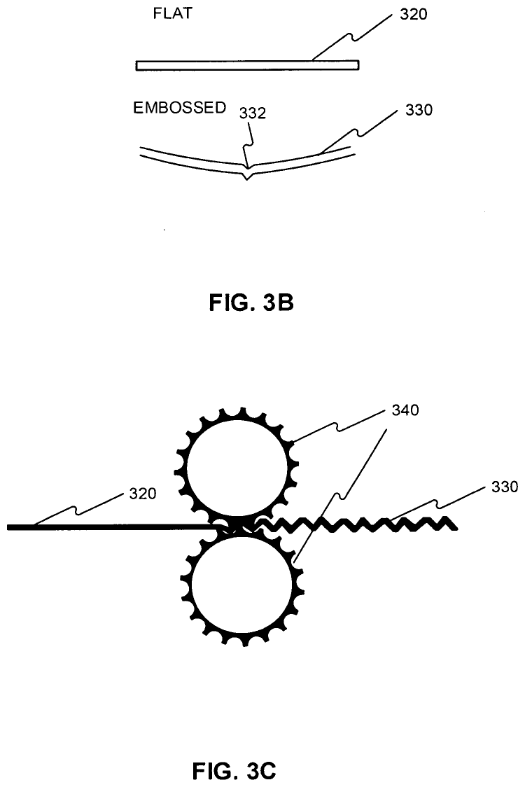

Referring again to FIG. 1, at step 120, multiple embossments may be embossed onto the sheet along corresponding folding lines. Reference are made to FIGS. 3A and 3B. FIG. 3A is an elevation view of an exemplary sheet 300 with folding lines 310, consistent with some embodiments of the disclosure. Sheet 300 in FIG. 3A can be the sheet 200A or 200B shown in FIG. 2A or 2B. In some embodiments, the folding lines 310 can be printed onto the sheet 300 in step 110. In some embodiments, the folding lines 310 are equally spaced, but the present disclosure is not limited thereto. In other embodiments, the folding lines 310 are unequally spaced. In some embodiments, the folding lines 310 do not punctuate the sheet 300.

FIG. 3B depicts a cross-sectional view of an exemplary embossed sheet 330 compared with a flat sheet 320, consistent with some embodiments of the disclosure. At step 120, on each of the needle leave, an embossment 332 can be embossed on the sheet 330 along the folding line 310 shown in FIG. 3A. For example, the embossment 332 can protrude from a surface of the sheet along the folding line 310, as shown in FIG. 3B. The tip of embossment 332 can coincide with the folding line 310. The embossment 332 can be configured to simulate the natural appearance of needles.

In some embodiments, step 120 further includes forming a curve across the folding line 310 in a core part of the needle. The curve can also be configured to simulate the natural appearance of needles. Accordingly, after step 120, each of the needle includes embossment 332 along corresponding folding line 310 being parallel to the direction of the needle.

At step 120, the embossing process may be performed by using various methods or industrial tools. For example, in some embodiments, a roller cutter, or other mechanical embossing tools, can be used to emboss a sheet by applying pressure on the sheet, without cutting the sheet. FIG. 3C illustrates an exemplary heated roller 340 for the embossing process, consistent with some embodiments of the disclosure. As shown in FIG. 3C, in some other embodiments, one or more heated rollers 340 can be used to emboss the flat PVC sheet 320. Particularly, Polyvinyl chloride (PVC) is considered a thermoplastic, which becomes moldable above a specific temperature and then returns back to a solid when cooled. Thus, the flat PVC sheet 320 can be exposed to a heated rolling die press to form into the embossed PVC sheet 330 with a curved shape, such as the embossed shape shown in FIG. 3C. By applying heating embossing, the flat PVC sheet 320 can be embossed into various possible shapes, such as jagged or curvaceous. For example, the embossing characteristics can be changed by changing the pattern of the heated roller 340. In some embodiments, a series of the heated roller 340 may be used.

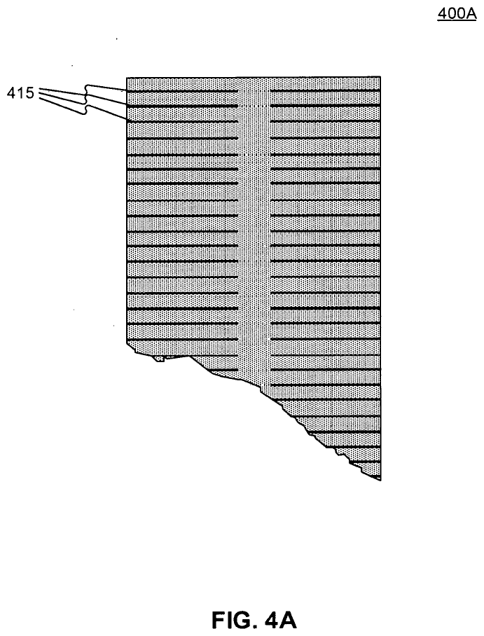

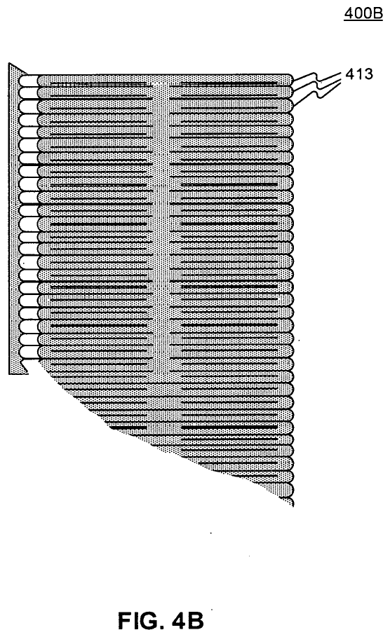

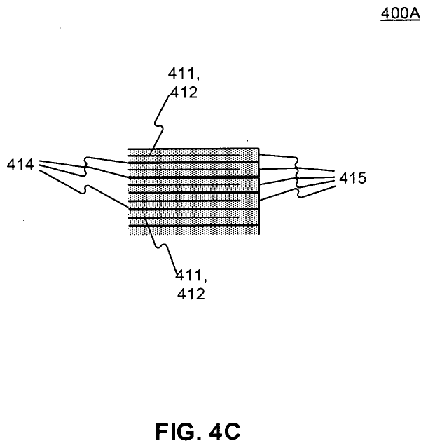

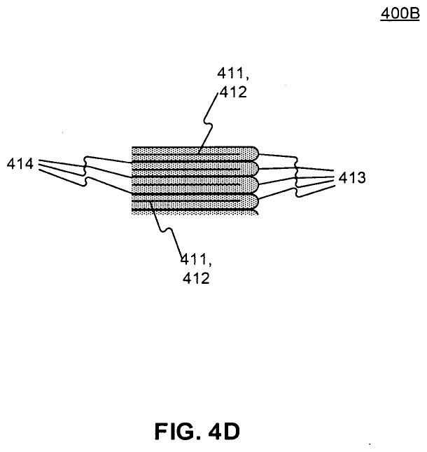

Referring again to FIG. 1, at step 130, the sheet was cut along cutting lines between the folding lines to form multiple needles. Reference is made to FIGS. 4A to 4D. FIGS. 4A to 4D are exemplary elevation views of the sheet after the cutting, consistent with some embodiments of the disclosure. Particularly, FIG. 4A illustrates an exemplary sheet 400A with straight-end edges 415 after the straight cutting, consistent with some embodiments of the disclosure. FIG. 4B illustrates an exemplary sheet 400B with rounded-end edges 413 after the rounding cutting, consistent with some embodiments of the disclosure. FIGS. 4C and 4D are enlarged views of regions in FIGS. 4A and 4B, respectively, consistent with some embodiments of the disclosure. Particularly, FIG. 4C illustrates a part of the straight cut sheet 400A including folding lines 411 and/or embossments 412, cutting lines 414 between two folding lines 411 of the two adjacent needles, and straight-end edges 415. FIG. 4D illustrates a part of the rounding cut sheet 400B including folding lines 411 and/or embossments 412, cutting lines 414 between two folding lines 411 of the two adjacent needles, and the rounded-end edges 413.

In some embodiments, the cutting lines 414 can also be printed onto the sheet 400A or 400B in step 110. In some embodiments, both the folding lines 411 and the cutting lines 414 are printed onto the sheet 400A or 400B in step 110, as shown in FIGS. 3A, 4A and 4B.

Accordingly, after the cutting performed in step 130, pairs of adjacent cutting lines 414 separate the sheet 400A or 400B into multiple units, and each individual unit can form an individual needle, in which straight-end edges 415 or rounded-end edges 413 can form tips of needles. That is, each of the needles has a first end connected to the central area (e.g., stem or midrib parts) and a second end forming the tip of the needle. Each needle includes the embossment 412 along the folding line 411 being parallel to a direction of the needle, and the second ends of two adjacent needles are separated by the cutting line 414 between the folding lines 411 of the two adjacent needles, In some embodiments, the printed pattern of each unit can be repeated. In some embodiments, the printed pattern of each unit can be different from the adjacent units to mimic the natural appearance of needles.

The cutting lines 414 and the folding lines 411 can be designed in various ways. In some embodiments, the cutting lines 414 and the folding lines 411 are alternated. In some embodiments, the cutting lines 414 are equally spaced. In some embodiments, the cutting lines 414 are unequally spaced. In some embodiments, the spaces between a folding line 411 and two adjacent cutting lines 414 are equal. In some embodiments, the spaces between a cutting line 414 and two adjacent folding lines 411 are equal. In some embodiments, the cutting lines 414 are longer than the folding lines 411.

At step 130, the cutting may be performed by using various cutting methods or industrial tools. For example, in some embodiments, a roller cutter with blades, or other mechanical cutting tools, can be used to cut the embossed sheet. In some other embodiments, a laser cutter can be used to cut the embossed sheet using laser beams. In some embodiments, a water jet cutter, also known as a “waterjet,” can be used to cut the embossed sheet using a high-pressure jet of water, or a mixture of water and an abrasive substance. In some embodiments, advantages of laser cutting include easier work holding, reduced contamination of workpiece, better precision and a smaller heat-affected zone. In some embodiments, the waterjet cutting can be used when the materials being cut are sensitive to the high temperatures generated by mechanical cutting tools.

In some embodiments, at step 130, the cutting may be performed with or without an additional straight cutting at the edge portion of the sheet 400A and thereby provide the straight-end edge 415, as shown in FIG. 4A and FIG. 4C. In some embodiments, at step 130, the cutting may be performed with rounding tips of the needles, and thereby generate rounded-end edges 413, as shown in FIG. 4B and FIG. 4D. In some embodiments, the lengths of needles can be the same, but the present disclosure is not limited thereto. In some embodiments, the lengths of needles are different.

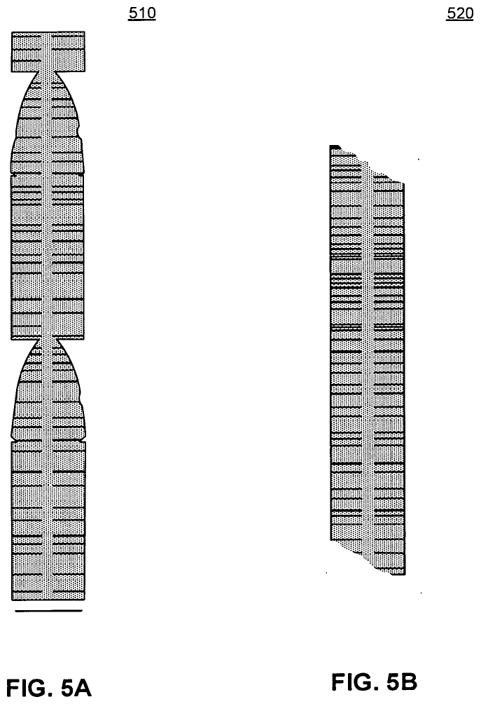

FIG. 5A illustrates an exemplary sheet 510 with needles having different lengths after the cutting, consistent with some embodiments of the disclosure. As shown in FIG. 5A, the edges of needles can be cut to form a shape or pattern with smooth edges. The different lengths of needles may mimic the natural appearance. In some embodiments, the process of cutting the edges of needles to obtain needles having different lengths can be performed at step 130 using the roller cutter, but the present disclosure is not limited thereto. In some embodiments, the cuttings applied to the embossed sheet along cutting lines to separate the needles and the cuttings applied to the edges of the needles can be performed separately by different cutting devices or methods. FIG. 5B illustrates an exemplary sheet 520 with needles having the same length after the cutting, consistent with some embodiments of the disclosure. As shown in FIG. 5B, in some other embodiments, the edges of needles can be cut to form needles having the same length on the sheet 520.

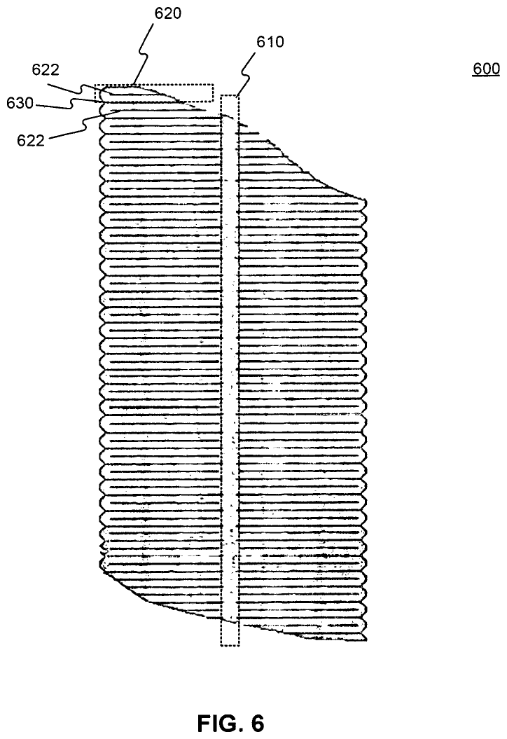

After steps 110, 120 and 130, the sheet for artificial tree needles can be generated and prepared for further steps for forming a needle (or leaf) part of an artificial tree. FIG. 6 illustrates an exemplary sheet 600 that undergoes printing, embossing and cutting, consistent with some embodiments of the present disclosure. As shown in FIG. 6, the resulted sheet 600 for artificial tree needles includes a central area 610 (e.g., a “spine”) and multiple needles 620. The first end of each needle 620 is connected to the central area 610, and the second ends, which may be rounded-end edges or straight-end edges, of two adjacent needles 620 are separated by a corresponding cutting line 630 between the folding lines 622 of the two adjacent needles 620. Each needle 620 also includes an embossment along the folding line 622 being parallel to the direction of the needle and may form forms a curve across the folding line 622 in a core part. In some embodiments, the needles 620 in the sheet 600 may have two or more needles with different lengths.

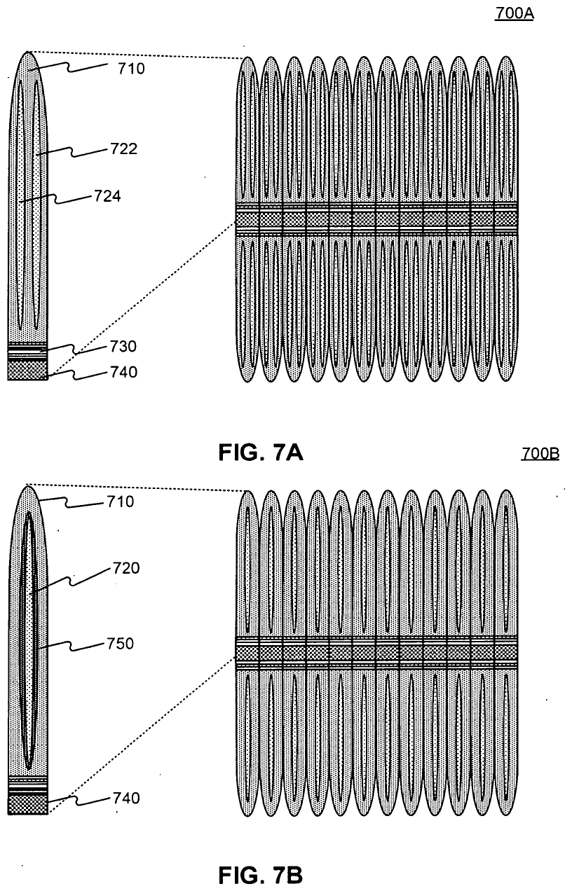

FIG. 7A and FIG. 7B illustrate exemplary alternative patterns 700A and 700B of the printed sheet, consistent with some embodiments of the present disclosure. As shown in FIG. 7A, in some embodiments, a needle may include multiple regions 710, 722, 724, 730 and 740 printed with different colors, variations in colors, and patterns. For example, in some embodiments, the region 710 may be printed with a green color (e.g., pantone 7273C), the regions 722 and 724, the “needle print” parts, may be printed with a different (lighter or darker) green color (e.g., pantone 556C), the region 730 may be printed with a yellow-green color (e.g., pantone 7492C), the region 740 may be printed with a brown color (e.g., pantone 1265C).

As shown in FIG. 7B, in some embodiments, a needle may include multiple regions 710, 720, 740, and 750 printed with different colors, variations in colors, and patterns. For example, in some embodiments, the region 710 may be printed with a green color (e.g., pantone 2409C), the region 720, the “needle print” part, may be printed with a different (lighter or darker) green color (e.g., pantone 556C), an edge portion 750 of the region 720 may be printed with a color darker than the region 710, the region 740 may be printed with another color (e.g., pantone 4072U). It would be appreciated that possible colors identified above are merely examples and not meant to limit the present disclosure.

Referring again to FIG. 1, in an optional step 140, the needles can be made from the cut sheet obtained from step 130. In some embodiments, the needles can be made by steps including slitting of PVC films or sheets into narrow lengths, forming a “roping” by twisting PVC films or sheets together with wires, and cutting the roping into parts having various lengths. In some embodiments, an automated spool can wind up the fringed sheet. The streams of the sheet travel over tension control guides.

A steel wire can unwind and then merge with the sheet, and then the machine twists the steel wire and one or more sheets together to create the roping. In some embodiments, an additional strip with a brown color can merge with the sheet and the steel wire, and land at the core part of the twisted fringe to create the illusion of a stem among the needles. It is noted that those skilled in the art understand that step 140 can be achieved by various ways, and the present disclosure is not limited by the methods described herein. Further explanations are omitted herein for the sake of brevity.

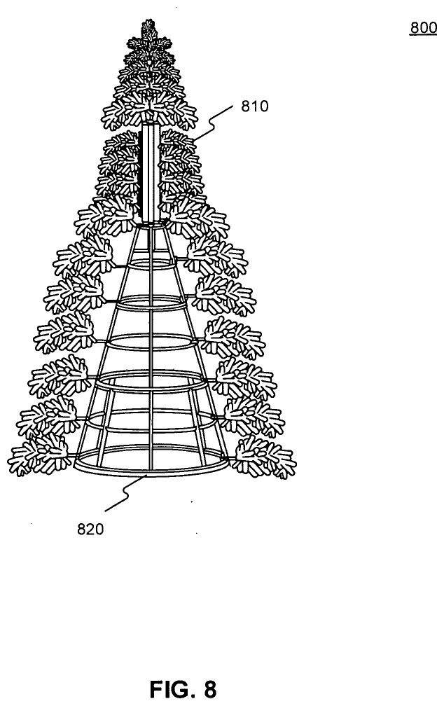

In an optional step 150, an artificial tree is made from the needles made in step 140. In some embodiments, the trees can be made, by taking the tips of various lengths and wrapping the tips on to a thicker, usually steel wire, to form a branch. This is accomplished by wrapping the tips to the wire with a yarn or string. The arrangement of the tips on to the wire can be done according to the desired look of the branch. FIG. 8 illustrates an exemplary intermediate stage of assembling an artificial tree 800, consistent with some embodiments of the present disclosure. As shown in FIG. 8, branch parts 810, which are made by a sheet including polymeric material, can be used to cover a steel skeleton 820 to make the artificial tree 800 with needles. In some embodiments, the steel skeleton 820 may be formed by assembling multiple pieces for a large artificial tree.

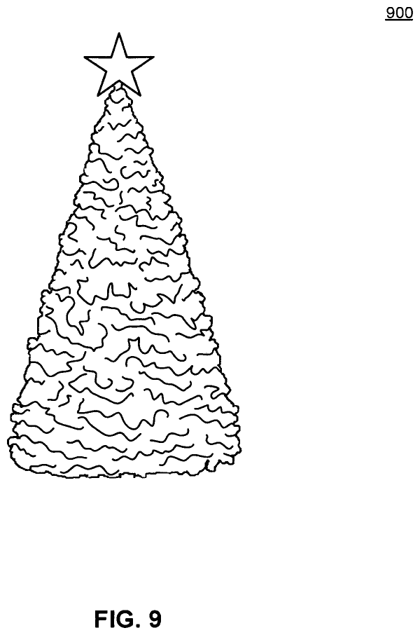

As discussed above, each of the branch parts 810 may include a midrib and needles extending from the midrib, in which a first end of the needle is connected to the midrib and a second end of the needle may include a rounded-end edge or a straight-end edge. Each needle may include an embossment along a folding line being parallel to a direction of the needle. Accordingly, a curve can be formed in the needle across the folding line in a core part of the needle. The midrib and the needles may be patterned with different colors. Needles in the same branch part may include two or more needles having different lengths. FIG. 9 illustrates an assembled artificial tree 900, consistent with some embodiments of the present disclosure. The embossments and variations in colors, patterns, or lengths can result in needles with a more realistic appearance in the artificial tree.

In some other embodiments, other decorative items can also be made from the needles made in step 140. For example, wreaths, garlands, or other products with needle-like tips can include branches, twigs, or decorative ornaments, such as holiday centerpieces, candleholders, etc. Similarly, various colors or patterns can be applied to these decorative items to provide realistic appearance.

Thus, cost-effective and lightweight artificial trees with realistic needles can be manufactured by using the sheets for artificial tree needles. In some embodiments, the artificial trees made by method may include multiple branches, in which each branch part includes a midrib and multiple needles extending from the midrib. A first end of the needle is connected to the midrib, and a second end of the needle forms the tip part. The embossment along the folding line of the needle and the curve across the folding line in the core part of the needle can make the artificial tree more lifelike realistic, without adding manufacturing costs or adding the weight of the artificial tree.

In some embodiments, the round-ended edges of the needles, different colors patterned on the central areas and the edge areas of the needles, and/or the variations of the lengths of the needles can further be applied to mimic the natural appearance of needles and provide more realistic visual effects to the artificial tree.

In the foregoing specification, embodiments have been described with reference to numerous specific details that can vary from implementation to implementation. Certain adaptations and modifications of the described embodiments can be made. Other embodiments can be apparent to those skilled in the art from consideration of the specification and practice of the disclosure disclosed herein. It is intended that the specification and examples be considered as exemplary only, with a true scope and spirit of the disclosure being indicated by the following claims. It is also intended that the sequence of steps shown in figures are only for illustrative purposes and are not intended to be limited to any particular sequence of steps. As such, those skilled in the art can appreciate that these steps can be performed in a different order while implementing the same method.

In the drawings and specification, there have been disclosed exemplary embodiments. However, many variations and modifications can be made to these embodiments. Accordingly, although specific terms are employed, they are used in a generic and descriptive sense only and not for purposes of limitation.

The embodiments may further be described using the following clauses:

1. A method of making needles of a decorative product, comprising:

embossing a plurality of embossments along a plurality of folding lines onto a sheet; and

cutting the embossed sheet along cutting lines between folding lines to form a plurality of needles.

2. The method according to clause 1, wherein the sheet comprises polymeric material.

3. The method according to clause 2, wherein the sheet comprises polyethylene, polyethylene terephthalate, polypropylene, polyvinyl chloride, polyurethane, polypropylene glycol, polystyrene, or any combination thereof.

4. The method according to clause 1, further comprising: printing a pattern onto the sheet, wherein the printing the pattern comprises:

patterning a first color at a central area of the sheet; and

patterning a second color at one or more edge areas of the sheet.

5. The method according to clause 1, wherein the embossing comprises:

forming a curve across the folding line in a core part of the needles.

6. The method according to clause 1, wherein the cutting comprises rounding tips of the needles.

7. The method according to clause 1, wherein the cutting comprises cutting opposite edges of the embossed sheet to form the needles of different lengths.

8. The method according to clause 1, wherein the embossing comprises embossing the plurality of embossments by a heated roller.

9. A sheet for making needles, comprising:

a central area; and

a plurality of needles, wherein each of the needles has a first end connected to the central area and a second end, and comprises an embossment along a folding line being parallel to a direction of the needle, the second ends of each of two adjacent needles being separated by a cutting line between the folding lines of the two adjacent needles.

10. The sheet for making needles of clause 9, wherein the sheet comprises polymeric material.

11. The sheet for making needles of clause 10, wherein the sheet comprises polyethylene, polyethylene terephthalate, polypropylene, polyvinyl chloride, polyurethane, polypropylene glycol, polystyrene, or any combination thereof.

12. The sheet for making needles of clause 9, wherein the central area is patterned with a first color and the plurality of needles are patterned with a second color.

13. The sheet for making needles of clause 9, wherein any of the needles forms a curve across the folding line in a core part.

14. The sheet for making needles of clause 9, wherein the second end of any of the plurality of needles comprises a rounded-end edge.

15. The sheet for making needles of clause 9, wherein the plurality of needles comprise two or more needles having different lengths.

16. An artificial tree, comprising:

a plurality of branch parts, each of the branch parts including a midrib and a plurality of needles extending from the midrib, wherein each of the needles has a first end connected to the midrib and a second end, and comprises an embossment along a folding line being parallel to a direction of the needle.

17. The artificial tree of clause 16, wherein any of the branch parts are made by a sheet comprising polymeric material.

18. The artificial tree of clause 16, wherein the midrib is patterned with a first color and the plurality of needles are patterned with a second color.

19. The artificial tree of clause 16, wherein any of the needles forms a curve across the folding line in a core part.

20. The artificial tree of clause 16, wherein the second end of any of the plurality of needles comprises a rounded-end edge.

What is claimed is:

1. A method of making needles of a decorative product, comprising:
embossing a plurality of embossments along a plurality of folding lines onto a sheet; and
cutting the embossed sheet along cutting lines between folding lines to form a plurality of needles.

2. The method according to claim 1, wherein the sheet comprises polymeric material.

3. The method according to claim 2, wherein the sheet comprises polyethylene, polyethylene terephthalate, polypropylene, polyvinyl chloride, polyurethane, polypropylene glycol, polystyrene, or any combination thereof.

4. The method according to claim 1, further comprising:
printing a pattern onto the sheet, wherein the printing the pattern comprises:
patterning a first color at a central area of the sheet; and
patterning a second color at one or more edge areas of the sheet.

5. The method according to claim 1, wherein the embossing comprises:
forming a curve across the folding line in a core part of the needles.

6. The method according to claim 1, wherein the cutting comprises rounding tips of the needles.

7. The method according to claim 1, wherein the cutting comprises cutting opposite edges of the embossed sheet to form the needles of different lengths.

8. The method according to claim 1, wherein the embossing comprises embossing the plurality of embossments by a heated roller.

9. A sheet for making needles, comprising:
a central area; and
a plurality of needles, wherein each of the needles has a first end connected to the central area and a second end, and comprises an embossment along a folding line being parallel to a direction of the needle, the second ends of each of two adjacent needles being separated by a cutting line between the folding lines of the two adjacent needles.

10. The sheet for making needles of claim 9, wherein the sheet comprises polymeric material.

11. The sheet for making needles of claim 10, wherein the sheet comprises polyethylene, polyethylene terephthalate, polypropylene, polyvinyl chloride, polyurethane, polypropylene glycol, polystyrene, or any combination thereof.

12. The sheet for making needles of claim 9, wherein the central area is patterned with a first color and the plurality of needles are patterned with a second color.

13. The sheet for making needles of claim 9, wherein any of the needles forms a curve across the folding line in a core part.

14. The sheet for making needles of claim 9, wherein the second end of any of the plurality of needles comprises a rounded-end edge.

15. The sheet for making needles of claim 9, wherein the plurality of needles comprise two or more needles having different lengths.

16. An artificial tree, comprising:
a plurality of branch parts, each of the branch parts including a midrib and a plurality of needles extending from the midrib, wherein each of the needles has a first end connected to the midrib and a second end, and comprises an embossment along a folding line being parallel to a direction of the needle.

17. The artificial tree of claim 16, wherein any of the branch parts are made by a sheet comprising polymeric material.

18. The artificial tree of claim 16, wherein the midrib is patterned with a first color and the plurality of needles are patterned with a second color.

19. The artificial tree of claim 16, wherein any of the needles forms a curve across the folding line in a core part.

20. The artificial tree of claim 16, wherein the second end of any of the plurality of needles comprises a rounded-end edge.
